(19) United States
(12) Patent Application Publication
(10) Pub. No.: US 2025/0266534 A1
(43) Pub. Date: Aug. 21, 2025

(54) WATER ELECTROLYSIS SYSTEM AND ENERGY SYSTEM

(71) Applicant: HONDA MOTOR CO., LTD., TOKYO (JP)

(72) Inventors: Koki TAMURA, WAKO-SHI (JP); Hiroshi YOSHIMURA, WAKO-SHI (JP)

(21) Appl. No.: 19/027,623

(22) Filed: Jan. 17, 2025

(30) Foreign Application Priority Data
Feb. 19, 2024 (JP) 2024-022662

(51) Int. Cl. H01M 16/00; C25B 1/04; C25B 13/02; C25B 15/08; H01M 8/04082; H01M 8/04828; H01M 8/0656

(52) U.S. Cl. CPC H01M 16/003; C25B 1/04; C25B 13/02; C25B 15/08; H01M 8/04201; H01M 8/04835; H01M 8/0656

(57) ABSTRACT

A water electrolysis system includes: a water electrolysis device including a membrane electrode assembly formed by sandwiching an electrolyte membrane between an anode and a cathode, the water electrolysis device being configured to generate oxygen gas at the anode by supplying water to the cathode and electrolyzing the water; and a water supply device configured to supply, to the anode, water generated in association with power generation of a fuel cell stack.

### CROSS-REFERENCE TO RELATED APPLICATIONS

This application is based upon and claims the benefit of priority from Japanese Patent Application No. 2024-022662 filed on Feb. 19, 2024, the contents of which are incorporated herein by reference.

### BACKGROUND OF THE INVENTION

### Field of the Invention

The present disclosure relates to a water electrolysis system and an energy system.

### Description of the Related Art

In recent years, technological development has been conducted on energy systems that contribute to energy efficiency in order to ensure that more people have access to affordable, reliable, sustainable and modern energy.

JP 2022-083098 A describes an energy system including a water electrolysis system, a compression (pressurizing) device, and a fuel cell. The water electrolysis system includes a water electrolysis device including a membrane electrode assembly formed by sandwiching an electrolyte membrane between an anode and a cathode. The water electrolysis device supplies water to the cathode and electrolyzes the water to generate oxygen gas at the anode.

### SUMMARY OF THE INVENTION

There has been a demand for a more satisfactory water electrolysis system and a more satisfactory energy system.

The present disclosure has the object of solving the above-described problem.

According to a first aspect of the present disclosure, there is provided a water electrolysis system comprising: a water electrolysis device including a membrane electrode assembly formed by sandwiching an electrolyte membrane between an anode and a cathode, the water electrolysis device being configured to generate oxygen gas at the anode by supplying water to the cathode and electrolyzing the water; and a water supply device configured to supply, to the anode, water generated in association with power generation of a fuel cell stack.

According to a second aspect of the present disclosure, there is provided an energy system comprising: the water electrolysis system according to the first aspect; and a fuel cell system including the fuel cell stack.

According to the present disclosure, a more satisfactory water electrolysis system and a more satisfactory energy system can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of an energy system according to an embodiment of the present disclosure;

FIG. 2 is an explanatory cross-sectional view of a water electrolysis cell;

FIG. 3 is a block diagram of a control device of the energy system; and

FIG. 4 is a flowchart showing an example of a method for controlling the energy system.

### DETAILED DESCRIPTION OF THE INVENTION

In a water electrolysis device, the anode may be corroded by oxygen gas generated at the anode. The present disclosure has been made in view of such a problem, and can provide a water electrolysis system and an energy system capable of suppressing corrosion of an anode.

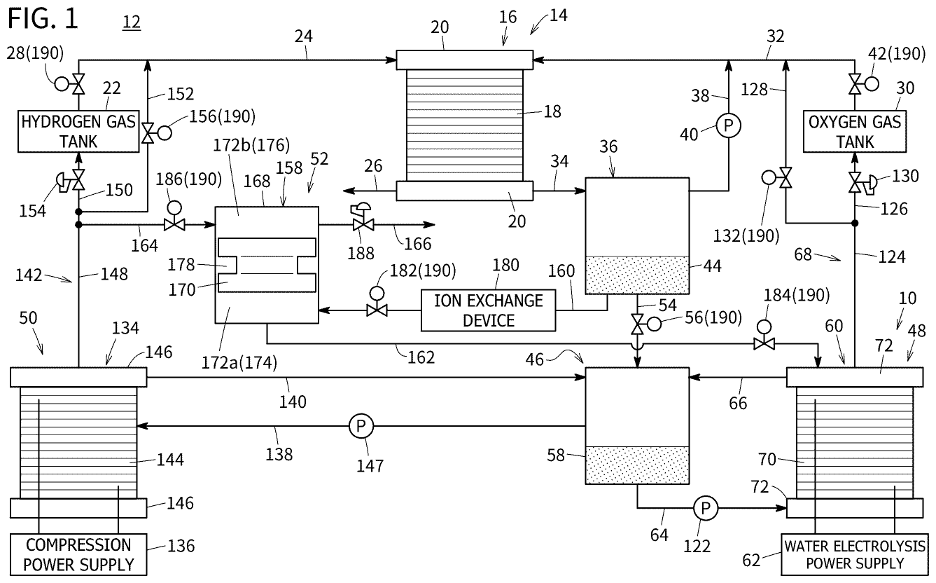

FIG. 1 is a schematic configuration diagram of an energy system 12 according to an embodiment of the present disclosure. The energy system 12 is a circulative renewable energy system. Specifically, the energy system 12 is a system in which a fuel cell system 14 that generates electricity and water by an electrochemical reaction between oxygen gas and hydrogen gas, and a water electrolysis system 10 that generates oxygen gas and hydrogen gas by electrolyzing water, are combined. In the energy system 12, the water electrolysis system 10 generates, by using water generated in the fuel cell system 14, oxygen gas and hydrogen gas required for power generation of the fuel cell system 14.

Such an energy system 12 can be installed, for example, on the ground or on the moon's surface. Further, the energy system 12 can also be mounted on a satellite such as an International Space Station (ISS).

The fuel cell system 14 includes a fuel cell stack 16. The fuel cell stack 16 includes a plurality of power generation cells 18 and a pair of end plates 20. The plurality of power generation cells 18 are stacked on each other. The pair of end plates 20 sandwich the plurality of power generation cells 18 in the stacking direction of the power generation cells 18.

The detailed illustration of the power generation cells 18 will be omitted. The power generation cells 18 each include a membrane electrode assembly and a pair of separators. The membrane electrode assembly is sandwiched between the pair of separators. The membrane electrode assembly includes an electrolyte membrane, an anode, and a cathode. The power generation cells 18 generate power by an electrochemical reaction between hydrogen gas and oxygen gas. Water is generated at the cathodes when power is generated by the power generation cells 18.

The fuel cell system 14 further includes a hydrogen gas tank 22, a hydrogen gas supply path 24, and a hydrogen gas discharge path 26. The hydrogen gas tank 22 is filled with high-pressure hydrogen gas. The hydrogen gas supply path 24 is configured to supply the hydrogen gas filled in the hydrogen gas tank 22 to the fuel cell stack 16. The hydrogen gas supply path 24 is provided with an on-off valve 28. The on-off valve 28 opens and closes the hydrogen gas supply path 24. A hydrogen exhaust gas discharged from the fuel cell stack 16 flows through the hydrogen gas discharge path 26. The hydrogen exhaust gas contains unreacted hydrogen gas that has not reacted in the power generation cells 18.

The fuel cell system 14 further includes an oxygen gas tank 30, an oxygen gas supply path 32, an oxygen gas discharge path 34, a gas-liquid separator 36, a circulation flow path 38, and an oxygen pump 40. The oxygen gas tank 30 is filled with high-pressure oxygen gas. The pressure of the oxygen gas in the oxygen gas tank 30 is lower than the pressure of the hydrogen gas in the hydrogen gas tank 22. The oxygen gas supply path 32 is configured to supply the oxygen gas filled in the oxygen gas tank 30 to the fuel cell stack 16. The oxygen gas supply path 32 is provided with an on-off valve 42. The on-off valve 42 opens and closes the oxygen gas supply path 32. An oxygen exhaust gas discharged from the fuel cell stack 16 flows through the oxygen gas discharge path 34. The oxygen exhaust gas contains unreacted oxygen gas that has not reacted in the power generation cells 18. The oxygen exhaust gas also contains water (water vapor) generated at the cathodes of the power generation cells 18.

The gas-liquid separator 36 is connected to the oxygen gas discharge path 34. The gas-liquid separator 36 separates the oxygen exhaust gas into gas and liquid. Specifically, the gas-liquid separator 36 removes water vapor from the oxygen exhaust gas. The gas-liquid separator 36 includes a reservoir portion 44 that stores water (liquid water) separated from the oxygen exhaust gas. The circulation flow path 38 connects the gas-liquid separator 36 and the oxygen gas supply path 32 to each other. The circulation flow path 38 guides the oxygen exhaust gas from which water vapor has been removed by the gas-liquid separator 36, to the oxygen gas supply path 32. The oxygen pump 40 is provided in the circulation flow path 38. The oxygen pump 40 sends the oxygen exhaust gas flowing through the circulation flow path 38, to the oxygen gas supply path 32.

The fuel cell system 14 may include components other than the above-described components. That is, the fuel cell system 14 may include, for example, a cooling device for circulating a coolant to the fuel cell stack 16.

The water electrolysis system 10 includes a gas-liquid separator 46, a water electrolysis device 48, a compression device 50, and a water supply device 52. The gas-liquid separator 46 of the water electrolysis system 10 and the gas-liquid separator 36 of the fuel cell system 14 are connected to each other by a connecting passage 54. The connecting passage 54 is provided with an on-off valve 56. The on-off valve 56 opens and closes the connecting passage 54. The water stored in the reservoir portion 44 of the gas-liquid separator 36 of the fuel cell system 14 is supplied to the gas-liquid separator 46 via the connecting passage 54. The gas-liquid separator 46 includes a cathode-side reservoir portion 58 that stores water. The water stored in the cathode-side reservoir portion 58 is supplied to a cathode 88 (described later) of the water electrolysis device 48.

The water electrolysis device 48 generates oxygen gas and hydrogen gas by electrolyzing water (pure water). The water electrolysis device 48 is, for example, a solid polymer water electrolysis device. The water electrolysis device 48 may be an alkaline water electrolysis device or a solid oxide water electrolysis device.

The water electrolysis device 48 includes a water electrolysis stack 60, a water electrolysis power supply 62, a water electrolysis supply path 64, a water electrolysis discharge path 66, and an oxygen gas delivery path 68. The water electrolysis stack 60 includes a plurality of water electrolysis cells 70 and a pair of end plates 72. The plurality of water electrolysis cells 70 are stacked on each other. The pair of end plates 72 sandwich the plurality of water electrolysis cells 70 in the stacking direction of the water electrolysis cells 70.

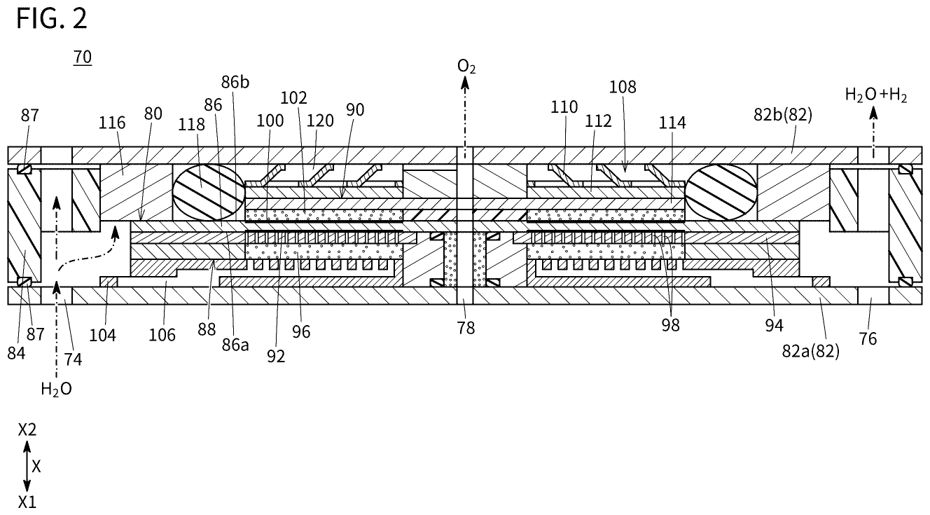

FIG. 2 is an explanatory cross-sectional view of the water electrolysis cell 70. In FIG. 2, an X direction is the stacking direction of the plurality of water electrolysis cells 70. As shown in FIG. 2, in the water electrolysis cell 70, water is supplied to the cathode 88. The water electrolysis cells 70 each generate oxygen gas at an anode 90 and hydrogen gas at the cathode 88 by electrolyzing water.

The water electrolysis cell 70 is a differential pressure water electrolysis cell in which the pressure of the oxygen gas in the anode 90 is higher than the pressure of the water in the cathode 88. The water electrolysis cell 70 may be an equal pressure water electrolysis cell in which the pressure of the oxygen gas in the anode 90 is substantially equal to the pressure of the water in the cathode 88. In the water electrolysis device 48, for example, oxygen gas at 14.8 MPa can be generated at the anodes 90.

The water electrolysis cells 70 each include a water supply passage 74, a water discharge passage 76, and an oxygen gas discharge passage 78 that are provided so as to penetrate the water electrolysis cell 70 in the X direction. The water supply passages 74 of the plurality of water electrolysis cells 70 communicate with each other. The water discharge passages 76 of the plurality of water electrolysis cells 70 communicate with each other. The oxygen gas discharge passages 78 of the plurality of water electrolysis cells 70 communicate with each other.

The water supply passage 74 and the water discharge passage 76 are provided at positions separated from each other in an outer peripheral portion of the water electrolysis cell 70. The oxygen gas discharge passage 78 is provided in a central portion of the water electrolysis cell 70. The oxygen gas discharge passage 78 is located between the water supply passage 74 and the water discharge passage 76. Water is supplied to the cathode 88 through the water supply passage 74. Water flowing through the cathode 88 and hydrogen gas generated at the cathode 88 are discharged to the outside through the water discharge passage 76. Oxygen gas generated at the anode 90 is discharged to the outside through the oxygen gas discharge passage 78.

The water electrolysis cells 70 each include a membrane electrode assembly 80, a pair of separators 82, and a frame member 84. The membrane electrode assembly 80 is sandwiched between the pair of separators 82. The frame member 84 is formed in an annular shape so as to surround the membrane electrode assembly 80. A seal member 87 for preventing a fluid (water and hydrogen gas) from flowing out is provided between the frame member 84 and each of the separators 82. Hereinafter, in FIG. 2, one of the pair of separators 82 that is located on an X1 direction side of the membrane electrode assembly 80 may be referred to as a “first separator 82a”, and the other of the pair of separators 82 that is located on an X2 direction side of the membrane electrode assembly 80 may be referred to as a “second separator 82b”.

The membrane electrode assembly 80 is formed in an annular shape. The membrane electrode assembly 80 includes an electrolyte membrane 86, the cathode 88, and the anode 90. The electrolyte membrane 86 is sandwiched between the cathode 88 and the anode 90. The electrolyte membrane 86 is an ion exchange membrane. Specifically, the electrolyte membrane 86 is, for example, an anion exchange membrane (AEM). The electrolyte membrane 86 may be a proton exchange membrane (PEM). The electrolyte membrane 86 prevents the oxygen gas generated at the anode 90 from passing through to the cathode 88.

The cathode 88 includes a cathode catalyst layer 92, a protective sheet 94, and a cathode current collector 96. The cathode catalyst layer 92 is joined to a surface 86a (a surface facing the X1 direction) of the electrolyte membrane 86. The cathode current collector 96 also serves as a gas diffusion layer for supplying water to the cathode catalyst layer 92. The cathode current collector 96 includes a portion formed of a porous member. The protective sheet 94 is disposed between the cathode catalyst layer 92 and the cathode current collector 96. The protective sheet 94 prevents the electrolyte membrane 86 from being damaged by being pressed by the cathode current collector 96 due to the high-pressure oxygen gas generated at the anode 90. A plurality of through holes 98 are formed in the protective sheet 94.

The outer diameter of the anode 90 is smaller than the outer diameter of the cathode 88. The anode 90 includes an anode catalyst layer 100 and an anode current collector 102. The anode catalyst layer 100 is joined to a surface 86b (a surface facing the X2 direction) of the electrolyte membrane 86. The anode current collector 102 also serves as a gas diffusion layer for leading out oxygen gas generated in the anode catalyst layer 100. The anode current collector 102 includes a portion formed of a porous member.

A support member 104 for supporting the membrane electrode assembly 80 is provided between the first separator 82a and the cathode current collector 96. A connection channel 106 is formed in the support member 104. The connection channel 106 guides the water introduced from the water supply passage 74 into the cathode current collector 96. Further, the connection channel 106 guides a mixed fluid of water and hydrogen gas in the cathode current collector 96 to the water discharge passage 76.

A load applying mechanism 108 that biases the anode current collector 102 in the X1 direction is provided between the second separator 82b and the anode current collector 102. The load applying mechanism 108 includes, for example, a plate spring 110, a plate spring holder 112, and a conductive sheet 114. An annular member 116 is provided between the second separator 82b and an outer peripheral portion of the electrolyte membrane 86. The annular member 116 is in liquid-tight and air-tight contact with the surface 86b of the electrolyte membrane 86.

An annular seal member 118 is disposed between the annular member 116 and the load applying mechanism 108. The seal member 118 is in liquid-tight and air-tight contact with the second separator 82b and the electrolyte membrane 86. A space (an anode chamber 120) for accommodating the anode 90 is formed on the inner side of the seal member 118. The load applying mechanism 108 is disposed in the anode chamber 120.

As shown in FIG. 1, the water electrolysis power supply 62 is a DC power supply. The water electrolysis power supply 62 applies a voltage between the cathode current collector 96 and the anode current collector 102 (see FIGS. 1 and 2).

The water electrolysis supply path 64 connects the cathode-side reservoir portion 58 and the water electrolysis stack 60. The water electrolysis supply path 64 communicates with the water supply passages 74 (see FIG. 2) of the water electrolysis cells 70. The water electrolysis supply path 64 guides the water stored in the cathode-side reservoir portion 58 to the water electrolysis stack 60. The water electrolysis supply path 64 is provided with a water pump 122. The water pump 122 sends the water flowing through the water electrolysis supply path 64, to the water electrolysis stack 60.

The water electrolysis discharge path 66 connects the gas-liquid separator 46 and the water electrolysis stack 60. The water electrolysis discharge path 66 communicates with the water discharge passages 76 (see FIG. 2) of the water electrolysis cells 70. The water electrolysis discharge path 66 guides, to the gas-liquid separator 46, a mixed fluid of hydrogen generated at the cathodes 88 of the water electrolysis cells 70 and water that has not been electrolyzed. The gas-liquid separator 46 separates the mixed fluid guided from the water electrolysis discharge path 66 into gas and liquid. The water separated from the mixed fluid is stored in the cathode-side reservoir portion 58.

The oxygen gas generated in the water electrolysis stack 60 is delivered to the fuel cell system 14 through the oxygen gas delivery path 68. The oxygen gas delivery path 68 communicates with the oxygen gas discharge passages 78 (see FIG. 2) of the water electrolysis cells 70. The oxygen gas delivery path 68 includes an oxygen gas lead-out path 124, a first branch path 126, and a second branch path 128. The oxygen gas lead-out path 124 is connected to the water electrolysis stack 60. The first branch path 126 and the second branch path 128 branch off from the oxygen gas lead-out path 124. The first branch path 126 is connected to the oxygen gas tank 30 of the fuel cell system 14. The second branch path 128 is connected to the oxygen gas supply path 32 of the fuel cell system 14.

The first branch path 126 is provided with a back pressure valve 130. The back pressure valve 130 opens in a case where the pressure of the oxygen gas guided from the water electrolysis stack 60 is equal to or higher than an oxygen gas pressure threshold determined in advance. The back pressure valve 130 closes in a case where the pressure of the oxygen gas guided from the water electrolysis stack 60 is less than the oxygen gas pressure threshold. The second branch path 128 is provided with an on-off valve 132. The on-off valve 132 opens and closes the second branch path 128.

The water electrolysis device 48 may include components other than the above-described components.

The compression device 50 includes a compression stack 134, a compression power supply 136, a compression supply path 138, a compression discharge path 140, and a hydrogen gas delivery path 142. The compression stack 134 compresses the hydrogen gas generated in the water electrolysis device 48. The compression stack 134 includes a plurality of compression cells 144 and a pair of end plates 146. The plurality of compression cells 144 are stacked on each other. The pair of end plates 146 sandwich the plurality of compression cells 144 in the stacking direction of the compression cells 144.

The detailed illustration of the compression cells 144 will be omitted. In each of the compression cells 144, a voltage is applied between an anode current collector of an anode and a cathode current collector of a cathode by the compression power supply 136 in a state where humidified hydrogen gas is supplied to the anode. Consequently, hydrogen ions are generated at the anode, and the hydrogen ions pass through the electrolyte membrane (the ion exchange membrane) of the compression cell 144 and are guided to the cathode. At the cathode, hydrogen ions are combined to generate hydrogen gas. The electrolyte membrane of the compression cell 144 prevents the hydrogen gas generated at the cathode from passing through to the anode. In the compression device 50, high-pressure hydrogen gas can be generated at the cathodes. The compression device 50 can compress the hydrogen gas to, for example, 70 MPa. That is, the pressure of the hydrogen gas compressed by the compression device 50 is higher than the pressure of the oxygen gas generated by the water electrolysis device 48.

The compression supply path 138 connects the gas-liquid separator 46 and the compression stack 134. The compression supply path 138 guides the hydrogen gas from which water is removed by the gas-liquid separator 46, to the compression stack 134. The compression supply path 138 is provided with a hydrogen pump 147. The hydrogen pump 147 sends the hydrogen gas flowing through the compression supply path 138, to the compression stack 134. It should be noted that the hydrogen gas supplied from the compression supply path 138 to the compression stack 134 contains an appropriate amount of water vapor. As a result, the electrolyte membranes of the compression cells 144 are humidified by the water vapor.

The compression discharge path 140 connects the gas-liquid separator 46 and the compression stack 134. The compression discharge path 140 guides the unreacted hydrogen gas in the compression stack 134 to the gas-liquid separator 46 together with the water vapor.

The hydrogen gas generated at the cathodes of the compression cells 144 is delivered to the fuel cell system 14 through the hydrogen gas delivery path 142. The hydrogen gas delivery path 142 includes a hydrogen gas lead-out path 148, a first branch path 150, and a second branch path 152. The hydrogen gas lead-out path 148 is connected to the compression stack 134. The first branch path 150 and the second branch path 152 branch off from the hydrogen gas lead-out path 148. The first branch path 150 is connected to the hydrogen gas tank 22 of the fuel cell system 14. The second branch path 152 is connected to the hydrogen gas supply path 24 of the fuel cell system 14.

The first branch path 150 is provided with a back pressure valve 154. The back pressure valve 154 opens the first branch path 150 in a case where the pressure of the hydrogen gas guided from the compression stack 134 is equal to or higher than a hydrogen gas pressure threshold determined in advance. The back pressure valve 154 closes the first branch path 150 in a case where the pressure of the hydrogen gas guided from the compression stack 134 is less than the hydrogen gas pressure threshold. The second branch path 152 is provided with an on-off valve 156. The on-off valve 156 opens and closes the second branch path 152.

The compression device 50 may include components other than the above-described components.

The water supply device 52 supplies water generated in association with power generation of the fuel cell stack 16, to the anodes 90 of the water electrolysis device 48. It should be noted that the pressure in the anode 90 to which the generated water is supplied is higher than the pressure in the cathode 88. The water supply device 52 includes a pressing device 158, a water introduction path 160, a water supply path 162, a hydrogen gas introduction path 164, and a discharge path 166. The pressing device 158 includes a cylindrical portion 168 and a piston 170. The piston 170 is provided in the cylindrical portion 168 so as to be slidable on an inner peripheral surface of the cylindrical portion 168. The piston 170 partitions an internal space of the cylindrical portion 168 into a first chamber 172a and a second chamber 172b. The first chamber 172a is an anode-side reservoir portion 174 capable of storing water to be supplied to the anodes 90 of the water electrolysis cells 70. The second chamber 172b is a pressurizing chamber 176 into which the hydrogen gas compressed by the compression device 50 can be introduced.

An outer peripheral surface of the piston 170 is in liquid-tight and air-tight contact with the inner peripheral surface of the cylindrical portion 168. An annular groove 178 is formed in the outer peripheral surface of the piston 170. An inert gas such as nitrogen gas is sealed in the annular groove 178. This can suppress mixing of the water in the anode-side reservoir portion 174 with the hydrogen gas in the pressurizing chamber 176.

The water introduction path 160 connects the reservoir portion 44 of the fuel cell system 14 and the cylindrical portion 168. The water introduction path 160 introduces water stored in the reservoir portion 44 of the fuel cell system 14 into the anode-side reservoir portion 174. In a case where water is introduced into the anode-side reservoir portion 174, the water may be pressure-fed by a pump (not shown).

Alternatively, the water may be introduced while increasing the space of the anode-side reservoir portion 174 by moving the piston 170 toward the pressurizing chamber 176 by discharging the gas in the pressurizing chamber 176 through a discharge valve 188 to reduce the pressure in the pressurizing chamber 176. The water introduction path 160 is provided with an ion exchange device 180 and an on-off valve 182. The ion exchange device 180 removes impurities from the water guided from the reservoir portion 44 of the fuel cell system 14. The on-off valve 182 opens and closes the water introduction path 160.

The water supply path 162 connects the cylindrical portion 168 and the water electrolysis stack 60. The water supply path 162 communicates with the anode chamber 120 (see FIG. 2) of each of the water electrolysis cells 70. Specifically, the water supply path 162 can guide the water (pure water) stored in the anode-side reservoir portion 174 to the anode 90 (see FIG. 2) of each of the water electrolysis cells 70. The water supply path 162 is provided with an on-off valve 184. The on-off valve 184 opens and closes the water supply path 162.

The hydrogen gas introduction path 164 connects the hydrogen gas delivery path 142 (the hydrogen gas lead-out path 148) and the cylindrical portion 168. The hydrogen gas introduction path 164 guides the hydrogen gas flowing through the hydrogen gas delivery path 142, to the pressurizing chamber 176 of the cylindrical portion 168. The hydrogen gas introduction path 164 is provided with an on-off valve 186. The on-off valve 186 opens and closes the hydrogen gas introduction path 164.

The hydrogen gas inside the pressurizing chamber 176 is discharged to the outside through the discharge path 166. The discharge path 166 is provided with the discharge valve 188. The discharge valve 188 opens and closes the discharge path 166. The discharge valve 188 opens in a case where the pressure in the pressurizing chamber 176 is equal to or higher than a pressure threshold determined in advance. The discharge valve 188 closes in a case where the pressure in the pressurizing chamber 176 is less than the pressure threshold.

The water supply device 52 may include components other than the above-described components.

In the water electrolysis system 10, the water supply device 52 and the water electrolysis stack 60 are arranged such that the potential energy of the anode-side reservoir portion 174 is higher than the potential energy of the anode 90 of each of the water electrolysis cells 70. Specifically, the height of the anode-side reservoir portion 174 in the gravity direction is greater than the height of the water electrolysis cells 70 in the gravity direction. As a result, the water stored in the anode-side reservoir portion 174 can be introduced to the anodes 90 of the water electrolysis cells 70 by using the potential energy.

In the following description, the on-off valves 28, 42, 56, 132, 156, 182, 184, and 186 described above may be simply referred to as an “on-off valve 190”.

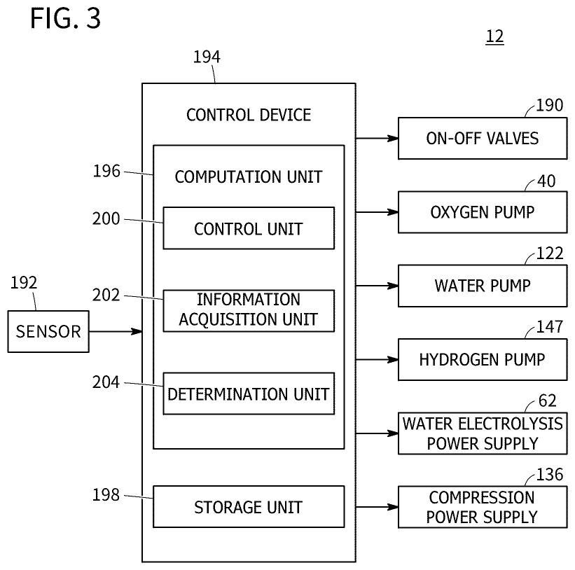

FIG. 3 is a block diagram of a control device 194 of the energy system 12. As shown in FIG. 3, the energy system 12 further includes a sensor 192 and the control device 194. The sensor 192 detects various kinds of information about the energy system 12. Detection signals of the sensor 192 are sequentially transmitted to the control device 194. The sensor 192 includes, for example, a water level sensor for measuring the amount of water in the anode-side reservoir portion 174. Further, the sensor 192 includes a voltage sensor for measuring the voltage between the cathode current collector 96 and the anode current collector 102 of each of the water electrolysis cells 70.

The control device 194 includes a computation unit 196 and a storage unit 198. The computation unit 196 is constituted by a processor such as a central processing unit (CPU) or a graphics processing unit (GPU). That is, the computation unit 196 is constituted by processing circuitry.

The computation unit 196 includes a control unit 200, an information acquisition unit 202, and a determination unit 204. The control unit 200, the information acquisition unit 202, and the determination unit 204 can be realized by the computation unit 196 executing programs stored in the storage unit 198.

At least part of the control unit 200, the information acquisition unit 202, and the determination unit 204 may be realized by an integrated circuit such as an application specific integrated circuit (ASIC) or a field-programmable gate array (FPGA). Further, at least part of the control unit 200, the information acquisition unit 202, and the determination unit 204 may be constituted by an electronic circuit including a discrete device.

The storage unit 198 is constituted by a volatile memory (not shown) and a non-volatile memory (not shown). Examples of the volatile memory include, for example, a random access memory (RAM) or the like. The volatile memory is used as a working memory of the processor and temporarily stores data and the like required for processing or computation. Examples of the non-volatile memory include, for example, a read only memory (ROM), a flash memory, or the like. The non-volatile memory is used as a storage memory and stores programs, tables, maps, and the like. At least part of the storage unit 198 may be included in the processor, the integrated circuit, or the like described above.

The control unit 200 controls the entire energy system 12. The control unit 200 controls the on-off valves 190, the oxygen pump 40, the water pump 122, the hydrogen pump 147, the water electrolysis power supply 62, and the compression power supply 136. The information acquisition unit 202 acquires information measured by the sensor 192.

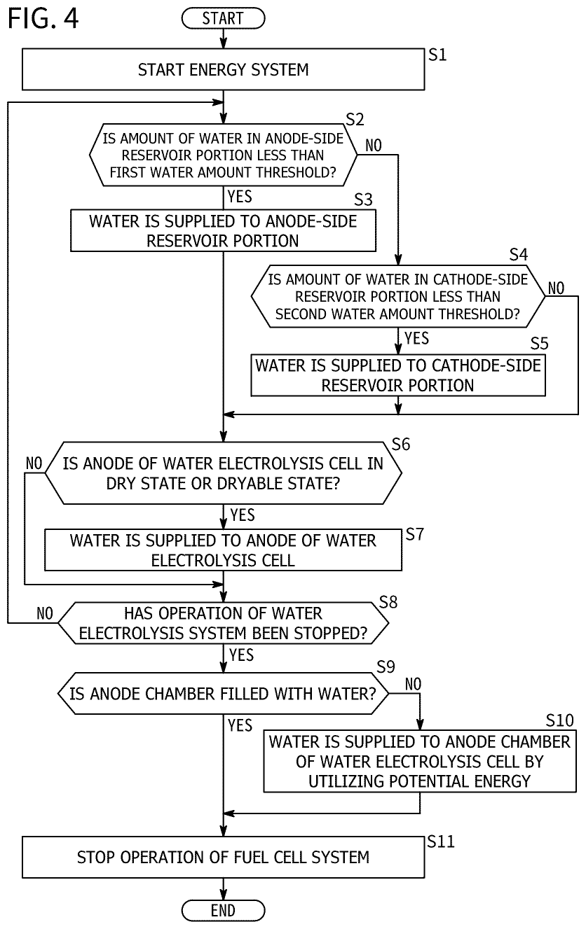

Next, the operation of the energy system 12 will be described. FIG. 4 is a flowchart showing an example of a method for controlling the energy system 12.

As shown in FIG. 4, in step S1, the control unit 200 starts the energy system 12. Specifically, the control unit 200 starts the fuel cell system 14. More specifically, the control unit 200 controls the on-off valve 42 to open the oxygen gas supply path 32, and controls the on-off valve 28 to open the hydrogen gas supply path 24. When the on-off valve 42 is opened, the oxygen gas filled in the oxygen gas tank 30 is introduced into the fuel cell stack 16 through the oxygen gas supply path 32. When the on-off valve 28 is opened, the hydrogen gas filled in the hydrogen gas tank 22 is introduced into the fuel cell stack 16 through the hydrogen gas supply path 24.

In the fuel cell stack 16, each of the power generation cells 18 generates electric power by an electrochemical reaction between oxygen gas and hydrogen gas. Unreacted hydrogen gas that has not been used for power generation is led out to the hydrogen gas discharge path 26 as hydrogen exhaust gas. Unreacted oxygen gas that has not been used for power generation is led out to the oxygen gas discharge path 34 as oxygen exhaust gas together with water generated in association with the power generation. The oxygen exhaust gas led out to the oxygen gas discharge path 34 is separated into gas and liquid by the gas-liquid separator 36. The water (liquid water) separated from the oxygen exhaust gas is stored in the reservoir portion 44. Moreover, the control unit 200 drives the oxygen pump 40 to guide the oxygen exhaust gas, from which water has been removed, from the gas-liquid separator 36 to the oxygen gas supply path 32.

The control unit 200 also starts the water electrolysis system 10. Specifically, the control unit 200 drives the water pump 122 and controls the water electrolysis power supply 62 to apply a voltage between the cathode current collector 96 and the anode current collector 102 of each of the water electrolysis cells 70. When the water pump 122 is driven, the water stored in the cathode-side reservoir portion 58 is supplied to the water supply passages 74 of the water electrolysis stack 60 via the water electrolysis supply path 64. The water supplied to each of the water supply passages 74 is guided to the cathode catalyst layer 92 through the connection channel 106 of the support member 104, the inside of the cathode current collector 96, and the through holes 98 of the protective sheet 94.

In a case where the electrolyte membrane 86 is an anion exchange membrane, hydrogen gas and hydroxide ions are generated in the cathode catalyst layer 92 by electrolysis of water. The hydroxide ions pass through the anion exchange membrane and are guided to the anode catalyst layer 100. In the anode catalyst layer 100, the hydroxide ions are combined to generate oxygen gas and water.

In a case where the electrolyte membrane 86 is a proton exchange membrane, the water guided to the cathode catalyst layer 92 passes through the proton exchange membrane and is guided to the anode catalyst layer 100. In the anode catalyst layer 100, oxygen gas and hydrogen ions are generated by electrolysis of water. The hydrogen ions pass through the proton exchange membrane and are guided to the cathode catalyst layer 92. In the cathode catalyst layer 92, hydrogen ions are combined to generate hydrogen gas.

The oxygen gas generated in the anode catalyst layer 100 is guided to the oxygen gas delivery path 68 through the oxygen gas discharge passage 78. It should be noted that, in the oxygen gas delivery path 68, the first branch path 126 is closed by the back pressure valve 130, and the second branch path 128 is closed by the on-off valve 132. Consequently, since the oxygen gas can be stored in the closed space, the pressure of the oxygen gas generated in the water electrolysis stack 60 can be increased. When the pressure of the oxygen gas generated in the water electrolysis stack 60 becomes equal to or higher than the oxygen gas pressure threshold, the back pressure valve 130 opens and the oxygen gas tank 30 is filled with the oxygen gas. It should be noted that the control unit 200 may supply the oxygen gas generated in the water electrolysis stack 60 to the oxygen gas supply path 32 by opening the on-off valve 132.

The mixed fluid of the hydrogen gas generated in the cathode catalyst layers 92 and the water that has not been electrolyzed is returned to the gas-liquid separator 46 via the water discharge passages 76 and the water electrolysis discharge path 66. The gas-liquid separator 46 separates the mixed fluid into gas and liquid. The water separated from the mixed fluid is stored in the cathode-side reservoir portion 58.

Further, the control unit 200 drives the hydrogen pump 147 and controls the compression power supply 136 to apply a voltage between the cathode current collector and the anode current collector of each of the compression cells 144. When the hydrogen pump 147 is driven, the hydrogen gas in the gas-liquid separator 46 is supplied to the anodes of the compression cells 144 via the compression supply path 138. In each of the compression cells 144, hydrogen ions generated at the anode pass through the electrolyte membrane and are guided to the cathode, and the hydrogen ions are combined at the cathode to generate hydrogen gas.

The hydrogen gas generated at the cathode is guided to the hydrogen gas delivery path 142. It should be noted that, in the hydrogen gas delivery path 142, the first branch path 150 is closed by the back pressure valve 154, and the second branch path 152 is closed by the on-off valve 156. Further, the hydrogen gas introduction path 164 is closed by the on-off valve 186. Consequently, since the hydrogen gas can be stored in the closed space, the pressure of the hydrogen gas generated in the compression stack 134 can be increased. When the pressure of the hydrogen gas generated in the compression cells 144 becomes equal to or higher than the hydrogen gas pressure threshold, the back pressure valve 154 opens and the hydrogen gas tank 22 is filled with the hydrogen gas. It should be noted that the control unit 200 may supply the hydrogen gas compressed by the compression stack 134 to the hydrogen gas supply path 24 by opening the on-off valve 156.

In the energy system 12, water is present at each of the anodes 90 during operation of the water electrolysis device 48. However, depending on the operation state of the water electrolysis cell 70, the anode 90 may be dried due to a shortage of water. In particular, in the differential pressure water electrolysis cell 70, the water in the anode 90 is pushed by the high-pressure oxygen gas and flows to the cathode 88 via the electrolyte membrane 86, and therefore, the anode 90 is likely to be dried. When the anode 90 is dried, the anode 90 (the anode current collector 102) may be corroded by the oxygen gas. In addition, a member provided in the anode chamber 120 (for example, the load applying mechanism 108) may be corroded. In the present embodiment, such corrosion of the anode 90 and the like is suppressed.

After the startup of the energy system 12 is finished, the process proceeds to step S2.

In step S2, the determination unit 204 determines whether or not the amount of water in the anode-side reservoir portion 174 is less than a first water amount threshold determined in advance. The amount of water in the anode-side reservoir portion 174 is acquired by the information acquisition unit 202 based on the detection signal of the sensor 192. The first water amount threshold is appropriately set based on the total capacity obtained by summing the capacities of the anode chambers 120 of the plurality of water electrolysis cells 70. In a case where the determination unit 204 determines that the amount of water in the anode-side reservoir portion 174 is less than the first water amount threshold (YES in step S2), the process proceeds to step S3.

In step S3, water is supplied to the anode-side reservoir portion 174. Specifically, the control unit 200 controls the on-off valve 182 to open the water introduction path 160. Then, the water stored in the reservoir portion 44 of the fuel cell system 14 is pushed by the oxygen exhaust gas in the gas-liquid separator 36 and is guided to the anode-side reservoir portion 174 via the water introduction path 160. It should be noted that the water guided to the anode-side reservoir portion 174 is pure water from which impurities have been removed by the ion exchange device 180. When the water is introduced into the anode-side reservoir portion 174, the hydrogen gas in the pressurizing chamber 176 is pushed by the piston 170 and discharged to the outside via the discharge path 166. It should be noted that the hydrogen gas flowing through the discharge path 166 is discharged in a state of being diluted with nitrogen gas. For example, when the amount of water in the anode-side reservoir portion 174 reaches the first water amount threshold, the control unit 200 controls the on-off valve 182 to close the water introduction path 160. This allows the amount of water in the anode-side reservoir portion 174 to be equal to or greater than the first water amount threshold. Thereafter, the process proceeds to step S6.

In a case where the determination unit 204 determines that the amount of water in the anode-side reservoir portion 174 is equal to or greater than the first water amount threshold (NO in step S2), the process proceeds to step S4.

In step S4, the determination unit 204 determines whether or not the amount of water in the cathode-side reservoir portion 58 is less than a second water amount threshold. The amount of water in the cathode-side reservoir portion 58 is acquired by the information acquisition unit 202 based on the detection signal of the sensor 192. The second water amount threshold is appropriately set based on the size of the water electrolysis stack 60, the size of the reservoir portion 44, and the like. In a case where the determination unit 204 determines that the amount of water in the cathode-side reservoir portion 58 is less than the second water amount threshold (YES in step S4), the process proceeds to step S5.

In step S5, water is supplied to the cathode-side reservoir portion 58. Specifically, the control unit 200 controls the on-off valve 56 to open the connecting passage 54. Then, the water stored in the reservoir portion 44 of the fuel cell system 14 is pushed by the oxygen exhaust gas in the gas-liquid separator 36 and is guided to the cathode-side reservoir portion 58 via the connecting passage 54. For example, when the amount of water in the cathode-side reservoir portion 58 reaches the second water amount threshold, the control unit 200 controls the on-off valve 56 to close the connecting passage 54. This allows the amount of water in the cathode-side reservoir portion 58 to be equal to or greater than the second water amount threshold. Thereafter, the process proceeds to step S6.

In step S6, the determination unit 204 determines whether or not the anode 90 of each of the water electrolysis cells 70 is in a dry state or a dryable state. Specifically, the determination unit 204 determines whether or not the anode 90 of each of the water electrolysis cells 70 is in a dry state or a dryable state, for example, based on a voltage value or a resistance value between the cathode current collector 96 and the anode current collector 102 of the water electrolysis cell 70. In a case where water is not introduced into the anode-side reservoir portion 174, then, in each of the water electrolysis cells 70, water is easily supplied to the cathode 88, whereas only water that has permeated through the electrolyte membrane 86 is supplied to the anode 90. Therefore, the anode 90 is a factor that increases the voltage value or the resistance value between the cathode current collector 96 and the anode current collector 102 of each of the water electrolysis cells 70. Therefore, it is possible to easily determine whether or not the anode 90 of each of the water electrolysis cells 70 is in a dry state or a dryable state. Further, the determination unit 204 may determine whether or not the anode 90 of each of the water electrolysis cells 70 is in a dry state or a dryable state based on, for example, the operation time of the water electrolysis stack 60. It should be noted that the dry state of the anode 90 refers to a state where the amount of water in the anode 90 is less than a water amount threshold determined in advance.

In a case where the determination unit 204 determines that the anode 90 of each of the water electrolysis cells 70 is in a dry state or a dryable state (YES in step S6), the process proceeds to step S7. On the other hand, in a case where the determination unit 204 determines that the anode 90 of each of the water electrolysis cells 70 is not in a dry state or a dryable state (NO in step S6), the process proceeds to step S8.

In step S7, water is supplied to the anode 90 of each of the water electrolysis cells 70. Specifically, the control unit 200 controls the on-off valve 186 to open the hydrogen gas introduction path 164, and controls the on-off valve 184 to open the water supply path 162. Then, the high-pressure hydrogen gas compressed by the compression stack 134 flows into the pressurizing chamber 176 from the hydrogen gas introduction path 164, and presses the piston 170 toward the anode-side reservoir portion 174. The water pushed by the piston 170 flows from the anode-side reservoir portion 174 into the anode chamber 120 of each of the water electrolysis cells 70 via the water supply path 162. Consequently, water is supplied to the anode 90. That is, the anode chamber 120 is filled with water. It should be noted that, in a case where the pressure of the hydrogen gas compressed by the compression stack 134 is higher than the pressure of the oxygen gas in the anode chamber 120 of each of the water electrolysis cells 70, the piston 170 can be moved by the pressure of the hydrogen gas in the pressurizing chamber 176. Moreover, in a case where the pressure of the hydrogen gas compressed by the compression stack 134 and the pressure of the oxygen gas in each of the water electrolysis cells 70 are close to each other, a differential pressure can be generated by reducing the electrolysis rate of the water electrolysis cell 70.

When the supply of water to the anode 90 of each of the water electrolysis cells 70 is finished, the control unit 200 controls the on-off valve 186 to close the hydrogen gas introduction path 164, and controls the on-off valve 184 to close the water supply path 162. Thereafter, the process proceeds to step S8.

In step S8, the determination unit 204 determines whether or not the operation of the water electrolysis system 10 has been stopped. The control unit 200 stops the operation of the water electrolysis system 10 in a case of receiving a shutdown signal for the water electrolysis system 10. In a case where the determination unit 204 determines that the operation of the water electrolysis system 10 has not been stopped (NO in step S8), the process proceeds to step S2. In a case where the determination unit 204 determines that the operation of the water electrolysis system 10 has been stopped (YES in step S8), the process proceeds to step S9.

In step S9, the determination unit 204 determines whether or not the anode chamber 120 is filled with water. Specifically, based on the voltage value or the resistance value between the cathode current collector 96 and the anode current collector 102 of each of the water electrolysis cells 70, the determination unit 204 determines whether or not the anode chamber 120 of the water electrolysis cell 70 is filled with water. Further, the determination unit 204 may determine whether or not the anode chamber 120 of the water electrolysis cell 70 is filled with water based on, for example, the operation time of the water electrolysis stack 60. It should be noted that a state where the anode chamber 120 is not filled with water refers to a state where the amount of water in the anode chamber 120 is less than a water amount threshold determined in advance.

In a case where the determination unit 204 determines that the anode chamber 120 is not filled with water (NO in step S9), the process proceeds to step S10. On the other hand, in a case where the determination unit 204 determines that the anode chamber 120 is filled with water (YES in step S9), the process proceeds to step S11.

In a case where the operation of the water electrolysis system 10 is being stopped, the hydrogen gas cannot be compressed by the compression device 50, and therefore, the water stored in the anode-side reservoir portion 174 cannot be pressed by the piston 170 in some cases. It should be noted that no oxygen gas is generated in the anode chamber 120 of each of the water electrolysis cells 70. In such a case, in step S10, water is supplied to the anode chamber 120 of the water electrolysis cell 70 by utilizing the potential energy. Specifically, the control unit 200 controls the on-off valve 184 to open the water supply path 162. As a result, the water stored in the anode-side reservoir portion 174 can be dropped to the anode chamber 120 via the water supply path 162 by the potential energy (gravity). Thus, the anode chamber 120 can be filled with water. Thereafter, the process proceeds to step S11.

In step S11, the control unit 200 stops the operation of the fuel cell system 14. According to this configuration, the state in which the anode 90 contacts with the oxygen gas during shutdown can be suppressed, and therefore, even during the shutdown, corrosion of the anode 90 of each of the water electrolysis cells 70 by the oxygen gas can be suppressed. Thereafter, the process shown in FIG. 4 is completed.

According to the present embodiment, the water generated in association with the power generation of the fuel cell stack 16 is supplied to the anodes 90 of the water electrolysis cells 70, and the contact area of the water with the anodes 90 can therefore be increased. In other words, the contact area of the oxygen gas with the anodes 90 can be reduced. This can suppress corrosion of the anodes 90 of the water electrolysis cells 70 by the oxygen gas. Therefore, a more satisfactory water electrolysis system 10 and a more satisfactory energy system 12 can be provided.

The following supplementary notes are further disclosed in relation to the above-described embodiment.

### Supplementary Note 1

The water electrolysis system (10) of the present disclosure includes: the water electrolysis device (48) including the membrane electrode assembly (80) formed by sandwiching the electrolyte membrane (86) between the anode (90) and the cathode (88), the water electrolysis device being configured to generate oxygen gas at the anode by supplying water to the cathode and electrolyzing the water; and the water supply device (52) configured to supply, to the anode, water generated in association with power generation of the fuel cell stack (16).

According to such a configuration, since the water generated in association with the power generation of the fuel cell stack is supplied to the anode of the water electrolysis device, the contact area of the water with the anode can be increased. In other words, the contact area of the oxygen gas with the anode can be reduced. This can suppress corrosion of the anode of the water electrolysis device by the oxygen gas. Therefore, a more satisfactory water electrolysis system can be provided.

### Supplementary Note 2

In the water electrolysis system according to Supplementary Note 1, the pressure of the oxygen gas in the anode may be higher than the pressure of the water in the cathode.

According to such a configuration, hydrogen generated on the cathode side is less likely to permeate through the electrolyte membrane and move to the anode side, and thus oxygen with higher purity can be generated.

### Supplementary Note 3

In the water electrolysis system according to Supplementary Note 1 or 2, the water supply device may include the anode-side reservoir portion (174) configured to store the water generated in association with the power generation of the fuel cell stack, and may supply the water stored in the anode-side reservoir portion to the anode during operation of the water electrolysis device.

According to such a configuration, it is possible to suppress deterioration due to an increase in resistance value associated with a shortage of the amount of water in the anode, which is caused by the water that has permeated through the electrolyte membrane being pushed back to the cathode side due to the differential pressure between the anode side and the cathode side during operation of the water electrolysis device.

### Supplementary Note 4

In the water electrolysis system according to Supplementary Note 3, the water supply device may include the water introduction path (160) configured to connect the anode-side reservoir portion with the reservoir portion (44) configured to store water obtained by gas-liquid separation of the oxygen exhaust gas discharged from the fuel cell stack.

According to such a configuration, since the water stored in the reservoir portion of the fuel cell stack is guided to the anode-side reservoir portion via the water introduction path, it is possible to suppress flowing of the oxygen exhaust gas of the fuel cell stack into the anode-side reservoir portion together with the water.

### Supplementary Note 5

The water electrolysis system according to Supplementary Note 3 or 4 may further include the compression device (50) including the compression cell (144) into which the hydrogen gas generated at the cathode is introduced, the compression cell being configured to compress the introduced hydrogen gas, wherein, during the operation of the water electrolysis device, the water supply device may pressure-feed the water stored in the anode-side reservoir portion to the anode using the pressure of the hydrogen gas compressed by the compression device.

According to such a configuration, the water stored in the anode-side reservoir portion can be supplied to the anode of the water electrolysis device by using the pressure of the hydrogen gas compressed by the compression device.

### Supplementary Note 6

In the water electrolysis system according to Supplementary Note 5, the pressure of the hydrogen gas that is increased by the compression device may be higher than the pressure of the oxygen gas that is generated at the anode.

According to such a configuration, the water stored in the anode-side reservoir portion can be smoothly pressure-fed to the anode of the water electrolysis device by the pressure of the hydrogen gas compressed by the compression device.

### Supplementary Note 7

In the water electrolysis system according to Supplementary Note 5 or 6, the water supply device may include the cylindrical portion (168) including the anode-side reservoir portion, the piston (170) provided in the cylindrical portion and configured to press the water stored in the anode-side reservoir portion, and the water supply path (162) configured to guide the water stored in the anode-side reservoir portion to the anode, and the hydrogen gas compressed by the compression device may press the piston to thereby pressure-feed the water stored in the anode-side reservoir portion to the anode via the water supply path.

According to such a configuration, the configuration of the water supply device can be simplified.

### Supplementary Note 8

The water electrolysis system according to any one of Supplementary Notes 3 to 7 may further include the cathode-side reservoir portion (58) configured to store the water to be supplied to the cathode, wherein, in a case where the amount of water in the anode-side reservoir portion is less than a water amount threshold determined in advance, the water generated in association with the power generation of the fuel cell stack may be supplied to the anode-side reservoir portion without being supplied to the cathode-side reservoir portion, and in a case where the amount of water in the anode-side reservoir portion is equal to or greater than the water amount threshold, the water generated in association with the power generation of the fuel cell stack may be supplied to the cathode-side reservoir portion.

According to such a configuration, the water generated in association with the power generation of the fuel cell stack can be used for water electrolysis of the water electrolysis device. Further, the water generated in association with the power generation of the fuel cell stack is supplied to the anode-side reservoir portion in preference to the cathode-side reservoir portion, and therefore, the shortage of the water to be supplied to the anode of the water electrolysis device can be suppressed.

### Supplementary Note 9

In the water electrolysis system according to any one of Supplementary Notes 3 to 8, the water supply device may supply the water stored in the anode-side reservoir portion to the anode during shutdown of the water electrolysis device.

According to such a configuration, it is possible to suppress corrosion of the anode by the oxygen gas during the shutdown of the water electrolysis device.

### Supplementary Note 10

In the water electrolysis system according to any one of supplementary Notes 5 to 7, during the shutdown of the water electrolysis device, the water supply device may supply the water stored in the anode-side reservoir portion to the anode by using potential energy.

According to such a configuration, even in a case where hydrogen gas cannot be generated due to the shutdown of the water electrolysis device, the water stored in the anode-side reservoir portion can be supplied to the anode by using the potential energy.

### Supplementary Note 11

In the water electrolysis system according to Supplementary Note 9 or 10, during the shutdown of the water electrolysis device, the water supply device may supply the water stored in the anode-side reservoir portion to the anode chamber (120) configured to accommodate the anode, to thereby fill the anode chamber with the water.

According to such a configuration, it is possible to suppress corrosion of the anode and the like accommodated in the anode chamber by the oxygen gas during the shutdown of the water electrolysis device.

### Supplementary Note 12

The energy system (12) of the present disclosure includes the water electrolysis system according to any one of Supplementary Notes 1 to 11, and the fuel cell system (14) including the fuel cell stack.

According to such a configuration, a more satisfactory energy system can be provided.

Although the present disclosure has been described in detail, the present disclosure is not limited to the above-described individual embodiments. Various additions, replacements, modifications, partial deletions, and the like can be made to these embodiments without departing from the gist of the present disclosure or without departing from the gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A water electrolysis system comprising:
a water electrolysis device including a membrane electrode assembly formed by sandwiching an electrolyte membrane between an anode and a cathode, the water electrolysis device being configured to generate oxygen gas at the anode by supplying water to the cathode and electrolyzing the water; and
a water supply device configured to supply, to the anode, water generated in association with power generation of a fuel cell stack.

2. The water electrolysis system according to claim 1, wherein
a pressure of the oxygen gas in the anode is higher than a pressure of the water in the cathode.

3. The water electrolysis system according to claim 1, wherein
the water supply device includes an anode-side reservoir portion configured to store the water generated in association with the power generation of the fuel cell stack, and supplies the water stored in the anode-side reservoir portion to the anode during operation of the water electrolysis device.

4. The water electrolysis system according to claim 3, wherein
the water supply device includes a water introduction path configured to connect the anode-side reservoir portion with a reservoir portion configured to store water obtained by gas-liquid separation of an oxygen exhaust gas discharged from the fuel cell stack.

5. The water electrolysis system according to claim 3, further comprising
a compression device including a compression cell into which hydrogen gas generated at the cathode is introduced, the compression cell being configured to compress the introduced hydrogen gas, wherein
during the operation of the water electrolysis device, the water supply device pressure-feeds the water stored in the anode-side reservoir portion to the anode using a pressure of the hydrogen gas compressed by the compression device.

6. The water electrolysis system according to claim 5, wherein
the pressure of the hydrogen gas that is increased by the compression device is higher than a pressure of the oxygen gas that is generated at the anode.

7. The water electrolysis system according to claim 5, wherein
the water supply device includes:
a cylindrical portion including the anode-side reservoir portion;
a piston provided in the cylindrical portion and configured to press the water stored in the anode-side reservoir portion; and
a water supply path configured to guide the water stored in the anode-side reservoir portion to the anode, and
the hydrogen gas compressed by the compression device presses the piston to thereby pressure-feed the water stored in the anode-side reservoir portion to the anode via the water supply path.

8. The water electrolysis system according to claim 3, further comprising
a cathode-side reservoir portion configured to store the water to be supplied to the cathode, wherein
in a case where an amount of the water in the anode-side reservoir portion is less than a water amount threshold determined in advance, the water generated in association with the power generation of the fuel cell stack is supplied to the anode-side reservoir portion without being supplied to the cathode-side reservoir portion, and
in a case where the amount of the water in the anode-side reservoir portion is equal to or greater than the water amount threshold, the water generated in association with the power generation of the fuel cell stack is supplied to the cathode-side reservoir portion.

9. The water electrolysis system according to claim 3, wherein
the water supply device supplies the water stored in the anode-side reservoir portion to the anode during shutdown of the water electrolysis device.

10. The water electrolysis system according to claim 5, wherein
during shutdown of the water electrolysis device, the water supply device supplies the water stored in the anode-side reservoir portion to the anode by using potential energy.

11. The water electrolysis system according to claim 9, wherein
during the shutdown of the water electrolysis device, the water supply device supplies the water stored in the anode-side reservoir portion to an anode chamber configured to accommodate the anode, to thereby fill the anode chamber with the water.

12. An energy system comprising:
the water electrolysis system according to claim 1; and
a fuel cell system including the fuel cell stack.
